(19) United States
(12) Patent Application Publication
(10) Pub. No.: US 2024/0323108 A1
(43) Pub. Date: Sep. 26, 2024

(54) VISUALIZATION TOOL FOR NETWORK TRAFFIC

(71) Applicant: International Business Machines Corporation, ARMONK, NY (US)

(72) Inventors: Zachary A. Silverstein, AUSTIN, TX (US); Logan Bailey, SANDY SPRINGS, GA (US); Jeremy R. Fox, AUSTIN, TX (US); Su Liu, AUSTIN, TX (US)

(21) Appl. No.: 18/187,279

(22) Filed: Mar. 21, 2023

(51) Int. Cl. H04L 43/045; G06T 19/00

(52) U.S. Cl. CPC H04L 43/045; G06T 19/006

(57) ABSTRACT

A tool for administering a computer network includes: an augmented reality (AR) device comprising a computing device and a viewer through which an administrator views a physical space comprising a part of the computer network; and an AR device module structured to identify data traffic on the computer network and display visual elements in an AR environment of the viewer that indicate activity on the computer network to the administrator.

### BACKGROUND

The Internet of Things (IoT) refers to a network of physical devices, vehicles, appliances, and other objects that are embedded with sensors, software, and connectivity, allowing them to connect and exchange data with each other and with other systems over the internet. IoT technology enables these devices to communicate with each other, collect and transmit data, and perform various tasks without human intervention, which can help improve efficiency, reduce costs, and enhance productivity in a wide range of industries and applications.

With so many devices becoming produces and consumers of data, the data traffic on a network, for example, a Local Area Network (LAN) becomes increasing complex. Thus, it becomes ever more difficult for an administrator to follow the interaction between networked devices so as to diagnose and remediate issues or optimize the network traffic.

### SUMMARY

According to an example of the present subject matter, a tool for administering a computer network is described. This tool includes: an augmented reality (AR) device comprising a computing device and a viewer through which an administrator views a physical space comprising a part of the computer network; and an AR device module structured to identify data traffic on the computer network and display visual elements in an AR environment of the viewer that indicate activity on the computer network to the administrator, a computer-implemented method is described.

In another example, this description includes a computer-implemented method for administering a computer network. The method includes: capturing Internet of Things (IoT) contexts and networking behavior for a number of networked devices; identifying source and destination addresses of payloads in the network; arranging information comprising the IoT contexts, networking behavior and source and destination addresses for display in an augmented reality (AR) space; and visualizing network activity in the AR space with visual elements representing the network activity displayed in a spatial arrangement corresponding to real-world components of the network viewed in the AR space.

In another example, this description includes a computer program product comprising a non-transitory, machine-readable medium that stores instructions. The instructions include: instructions for a traffic monitor to monitor traffic on a computer network; instructions for a digitizer to convert information on network activity obtained by the traffic monitor for display in an augmented (AR) reality environment; and instructions for a display elements generator to generate visual elements in the AR environment that correspond to different aspects of the network activity occurring the computer network. The visual elements represent differently local traffic and encrypted traffic.

### BRIEF DESCRIPTION OF THE DRAWINGS

FIG. 1 depicts a computing environment for the execution of a computer-implemented method or application, according to an example of the principles described herein.

FIG. 2A is a flowchart illustrating a method of operating an example of the tool described herein.

FIG. 2B is a flowchart illustrating a method of operating another example of the tool described herein.

FIG. 3A is a diagram of an example of the tool described herein and its operation.

FIG. 3B is a diagram of another example of the tool described herein and its operation.

FIG. 4 is an example of an augmented reality view using an example of the tool described herein.

FIG. 5 is a diagram of a machine-readable storage medium for implementing an example of the tool described herein.

### DETAILED DESCRIPTION

As noted above, the increasing number of networked devices makes it ever more difficult for a network administrator to grasp the flow of data traffic around the network. Thus, it becomes ever more difficult for an administrator to follow the interaction between networked devices so as to diagnose and remediate issues or optimize the network traffic. This is a technical problem.

Consequently, the following description will explain a technical solution to this technical problem. The technical solution includes a tool that assists a network administrator to visualize the flow of traffic on a network, such as a Local Area Network (LAN). This tool enables the administrator to see the interaction between components on the network so as to identify issues needing remediation or simply to optimize the network traffic. In some examples, the tool can be used to issue commands that alter the network traffic.

Visualizations are graphical representations of data or information that are designed to help people better understand and interpret complex or abstract concepts, patterns, trends, or relationships. Some of the simplest forms of visualization are charts and graphs, such as pie charts or bar graphs, that visually convey relationships and meaning from underlying data. These and other forms of visualization can be printed or displayed on an electronic display. As noted, the tool described here includes the ability to visualize network activity for an administrator.

Within a network, data traffic is handled and routed by switches. A switch is a networking device that connects devices on a LAN, for example, at the data link layer (Layer 2) of the Open Systems Interconnection (OSI) model. Switches are responsible for forwarding data packets between network devices based on the respective Internet Protocol (IP) or Media Access Control (MAC) addresses of the devices. Some switches operate on a two-queue model, where priority and control traffic are separated into Q0 and all other traffic is placed into Q1. However, Q0 is not, by default, set as the priority queue. This means that Q0 and Q1 have equal access to the switch fabric, and there is no guaranteed bandwidth allocation or priority handling for Q0 traffic. This original queue structure can be modified using Quality of Service (QOS) configuration to prioritize different types of traffic based on their importance and requirements. QoS can be used to provide better performance and ensure that critical traffic, such as voice or video, is given higher priority and guaranteed bandwidth over less important traffic.

Network traffic can be tracked in a variety of ways, often through a web browser or separate application and using Operating System level information. However, seeing this information in a tabular format, for example, may not always provide a complete understanding of the dynamic components and traffic associated with a given device. To gain a deeper understanding of network traffic, an administrator may use more advanced network monitoring and analysis tools, such as network analyzers or packet sniffers. These tools capture and analyze network traffic in real-time, providing detailed information about packet headers, payloads, and other network parameters. Such network monitoring and analysis tools can help network administrators and engineers troubleshoot and optimize network performance, detect and resolve security threats, and identify patterns and trends in network traffic. They can also provide visualization tools, such as flow diagrams or heat maps, to help visualize network traffic and identify areas of congestion or potential bottlenecks. The tool described here goes beyond these previous visualizations of network activity.

5G is the fifth generation of mobile networks, designed to offer faster internet speeds, lower latency, and support for a larger number of devices than previous generations. In 5G networks, slicing is a technology that allows network operators to create multiple virtual networks, or “slices,” within a single physical 5G network infrastructure. Each slice can be customized to meet the specific needs of different applications or use cases, such as autonomous vehicles, industrial automation, or virtual reality. With network slicing, each virtual network is allocated a dedicated set of network resources, including bandwidth, latency, and quality of service (QOS) parameters. This allows network administrators to tailor the network performance to the specific needs of each application, ensuring that critical applications receive the necessary resources while less demanding applications do not consume unnecessary resources. For example, a slice for autonomous vehicles may require low latency and high bandwidth, while a slice for industrial automation may require high reliability and low latency. By creating separate slices for each application, network operators can optimize the network performance and ensure that each application receives the necessary resources to function properly.

A Virtual Private Network (VPN) allows a user to create a secure and private connection over the internet. When using a VPN, the user's device establishes an encrypted connection or “tunnel” to a remote VPN server. Once the connection is established, all of the internet traffic can be routed through the encrypted tunnel to the VPN server, which acts as an intermediary between the user's device and the internet. This helps to protect online privacy and security by encrypting the user's data and hiding the user's Internet Protocol (IP) address and location.

VPN split tunneling is a feature that allows use of a VPN connection for some online activity while letting other traffic flow directly through a regular, unencrypted internet connection. The VPN software creates a list of IP addresses, domain names, or applications that should be routed through the VPN connection. Any traffic that matches the list is sent through the virtual network interface and is encrypted and tunneled through the VPN connection. Any traffic that doesn't match the list is sent through a regular network interface and is not encrypted or tunneled through the VPN connection. Within this context, administrators need tools to visualize traffic that distinguishes between encrypted, e.g., VPN, and non-encrypted data. Administrators also need tools to visualize traffic on and between devices, including visualizations that highlight network traffic based on QoS level and devices assigned to different QoS levels. This will allow augmentation of the visualized network traffic according to download resource or upload target.

As noted above, the Internet of Thing (IoT) refers to a network of physical devices, vehicles, appliances, and other objects that are embedded with sensors, software, and connectivity, allowing them to connect and exchange data with each other and with other systems over the internet. IoT technology enables these devices to communicate with each other, collect and transmit data, and perform various tasks without human intervention, which can help improve efficiency, reduce costs, and enhance productivity in a wide range of industries and applications. The term IoT context refers to the different types of networks and communication protocols used to connect and communicate with IoT devices, which can vary depending on the specific use case, application, and environment. Some common IoT network contexts include local area networks (LANs), wide area networks (WANs), cellular networks, low-power wide area networks (LPWANs), and mesh networks. Each context may use different communication protocols such as Wi-Fi, Bluetooth, Zigbee, LoRaWAN, or cellular standards like LTE-M or NB-IoT. The choice of network context and protocol depends on factors such as the distance between devices, the amount of data being transmitted, the required level of security, and power consumption requirements. Augmented reality, mixed reality and virtual reality are technologies that can all be used to provide visualization tools. Virtual reality (VR) is a digital environment that seeks to exclude the real world in the sensory input of a human user. Augmented reality (AR) allows the user to still perceive the real world but to also see digital content displayed over perceptions of the real world. For example, the user may observe the real world through a transparent display device while the transparent display device also displays digital content at locations in the field of view that correspond to real world objects also being perceived through the transparent display device. Mixed reality (MR) is a technology that blends the physical world with digital content, allowing users to interact with and manipulate virtual objects that appear to coexist in the same space as the real world. It combines elements of virtual reality and augmented reality to create a seamless and immersive experience.

The tool described by the present specification makes use of an augmented reality environment, although VR and MR environments can also be used according to the principles disclosed herein. In various examples, the tool provides a visualization of classified network traffics, including IoT contexts. The tool and its operational method can analyze IoT network contexts and then transform the source, destination, magnitude, and payload metadata into a visually understandable manner for network communications.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse or any given order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used in the present specification and in the appended claims, the term “a number of” or similar language is meant to be understood broadly as any positive number including 1 to infinity.

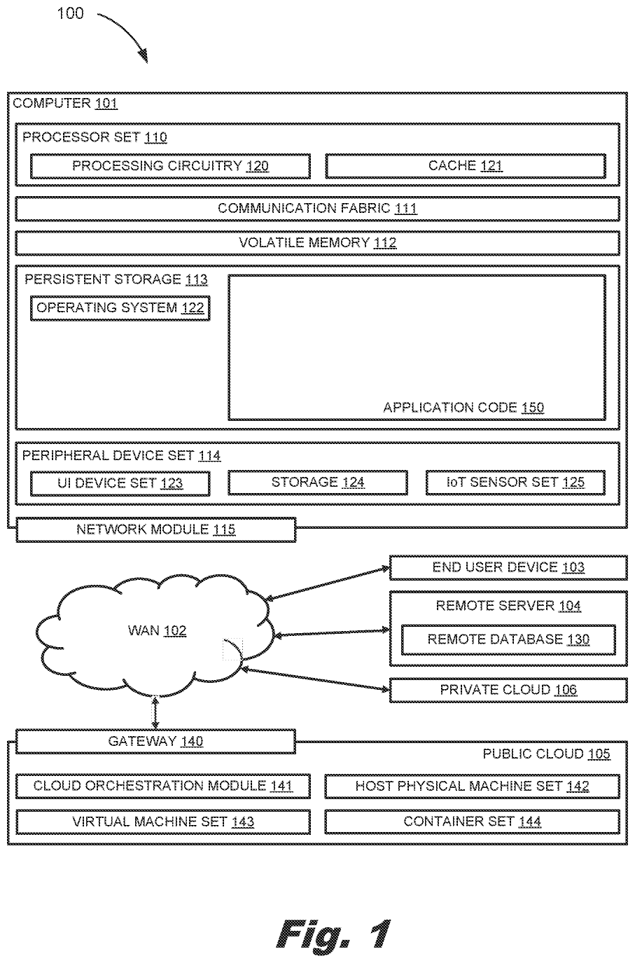

Turning now to the figures, FIG. 1 depicts a computing environment 100 for implementation of the principles described in the present specification. This computing environment can be used to understand and define a device providing the visualization tool described herein.

Computing environment 100 contains an example of an environment for the execution of at least some of the computer code involved in performing the inventive methods and an application to help provide the visualization tool described. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

The EUD 103 may be a client device operated by a producer of services or products that wants an analysis of available user data to ascertain user satisfaction. Operation of the EUD 103 for this objective will be described in further detail below.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

As described further below, the EUD 103 may use the network 102 to access an application on remote server 104. The application will access, again using the network 102, available user data. The application will then analyze the user data, with context specific analysis, to ascertain user satisfaction and generate recommendations for the producer based on the analysis.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

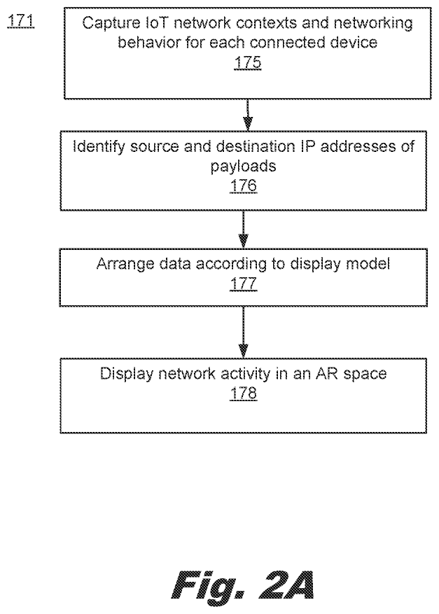

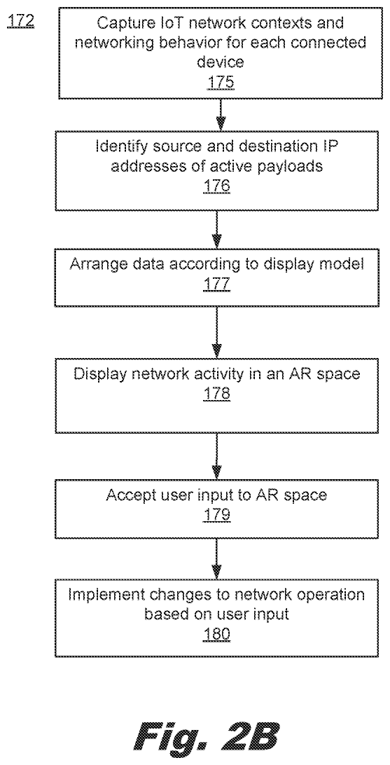

FIG. 2A is a flowchart illustrating a method 171 of operating an example of the tool described herein. Conceptually, a tool according to the present specification can begin by capturing 175 the IoT context and the networking behavior for each connected device on a network, for example a Local Area Network (LAN). As noted above, the term IoT context refers to the different types of networks and communication protocols used to connect and communicate with IoT devices, which can vary depending on the specific use case, application, and environment.

With this information, the tool will then identify 176 the source and destination Internet Protocol (IP) addresses of payloads moving within the network. This is done by sniffing packets moving via the network. The collected information provides the tool with data that characterizes the current state and operation of the network, e.g., devices that are actively communicating, how they are communicating and the source and destination of the payloads moving in the network. The tool may also consider network activity recently completed within some specified period of time.

Next, the tool will arrange 177 this data according to a visualization display model. There may be a number of different display models that use different colors, shapes, icons or elements to visually represent the activity in the network. A user, such as a network administrator, may select a preferred display model using a user interface of the tool.

Lastly, the tool will display 178 the network activity in an augmented reality (AR) space. This includes display the network activity using the selected display model as visual elements that are overlayed on a real world view of the components of the network. For example, the administrator using the tool may be wearing a viewer, e.g., AR googles or an AR visor, that includes a transparent display through which the administrator sees the actual real-world components of the network. On the transparent display, the visual elements of the selected display model indicating the network activity are displayed over, near or on the actual devices or network components involved in the network activity represented.

FIG. 2B is a flowchart illustrating a method 172 of operating another example of the tool described herein. In this method, the user, such as a network administrator, is able to visualize the network activity using the AR tool and is also able to provide user input to adjust or control the network activity using the AR tool.

An augmented reality device allows users to input information and commands via a user interface in a variety of ways. Some such methods include: (1) Voice commands: Users can speak commands or dictate text into a microphone on the device. The device then uses speech recognition technology to convert the audio input into text or actions. (2) Gesture recognition: Users can use hand or body gestures to interact with the device. The device uses sensors such as cameras, accelerometers, and gyroscopes to detect the user's movements and translate them into actions. (3) Touchscreen interface: Some augmented reality devices have a touchscreen display that users can interact with using their fingers or a stylus. This allows users to input text, select options, and navigate through menus. (4) Eye tracking: Some advanced augmented reality devices use eye tracking technology to detect where the user is looking. This can be used to select options or input text simply by looking at the appropriate place on the screen. Any of these user interface components and other techniques for receiving user input can be used by the AR tool being described by this specification.

Consequently, as illustrated in FIG. 2B, the method 172 includes the same elements as described above in FIG. 2A. However, method 172 also includes accepting user input 179 to the AR space. For example, using any of the input mechanisms listed above or others, the administrator operating the AR tool issues instructions or commands regarding the network activity that is being tracked and visualized by the tool. The tool then implements these instructed changes 180 in the network operation. For example, the administrator may pause a payload transmission occurring, possibly so as to observe the effect on other operations in the network. In some embodiments, the administrator can visually see and then allow or disallow specific traffic or non-traffic to go through based on AR interaction.

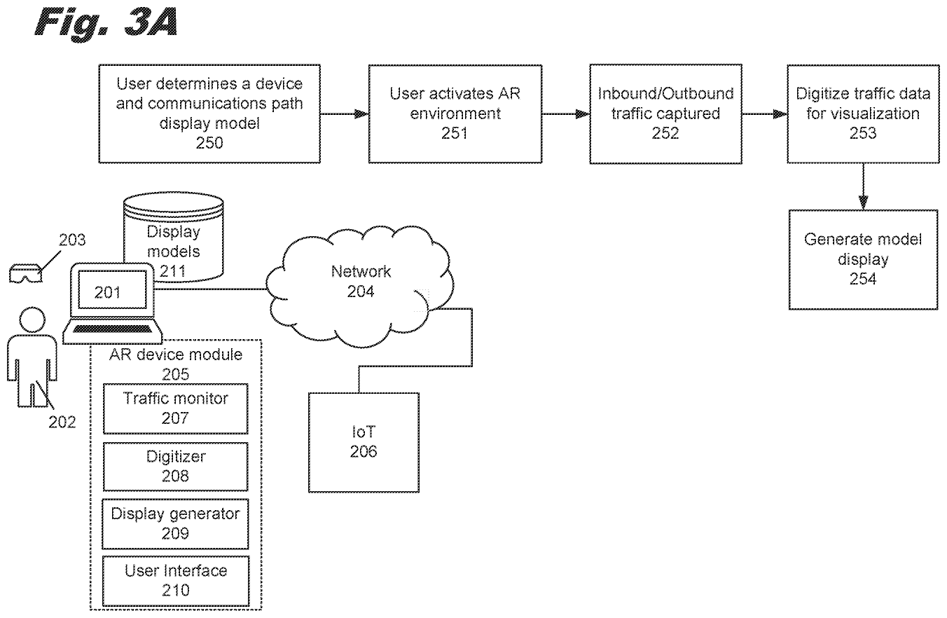

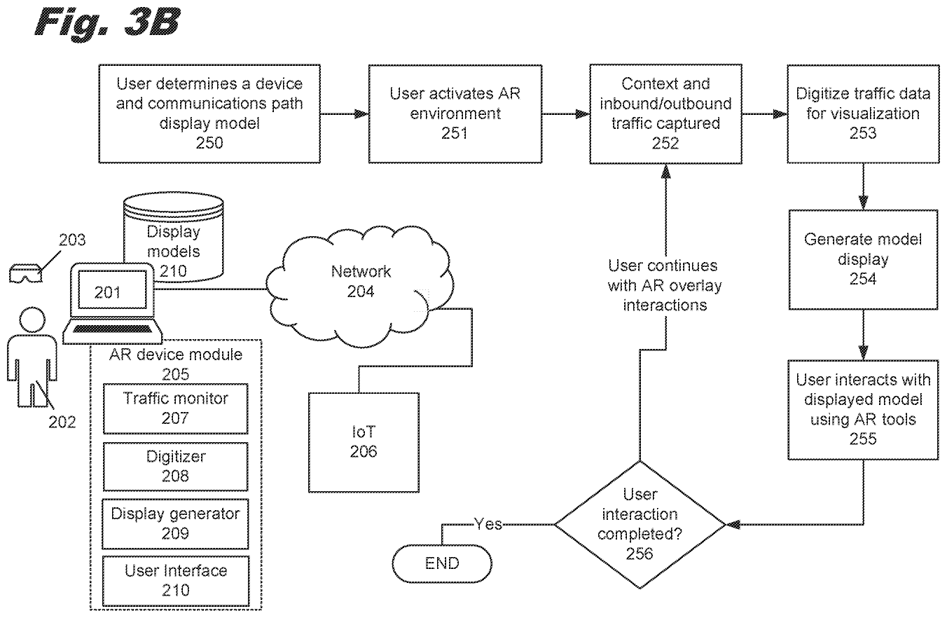

FIG. 3A is a diagram of an example of the tool described herein and its operation. As shown in FIG. 3A, the tool may utilize an augmented reality (AR) device 201. This AR device 201 may include the architecture described above with respect to FIG. 1 and may be implemented in a computer, laptop, desktop, table computer, mobile computing device or other processing device. The device will include a viewer 203 which may be implemented as googles, a visor, glasses, a single eyepiece or other configurations. The viewer 203 includes a transparent display device through which the administrator 202 can view the real world while allowing the AR device 201 to also display graphical elements that appear to overlay the real-world scene being viewed so as to give additional information about the real-world scene being viewed. In the present specification, this includes visualization elements that define network activity in conjunction with the electronic components that are involved in that activity.

The AR device 201 is connected to a network 204, for example a Local Area Network (LAN). The network 204 also connects with a number of other networked devices including a number of IoT devices 206. Any number of different IoT devices and other devices may be interconnected by the network 204. The network 204 may include both wired and wireless connections between networked devices.

The AR device 201 includes an AR device module 205 that implements the tool being described herein. In some examples, this module 205 may be an application running on a general purpose computer. In other examples, the module 205 may be other software executing on a purpose-specific computer for implementing the tool being described. In other examples, the module 205 may be an Application Specific Integrated Circuit (ASIC) or similar hardware structured specifically for implementing the tool being described. There may be a corresponding agent module installed on each of the network devices (e.g., 206) to report information, such as packet sniffing, to the module 205 from which the AR environment is generated.

The AR device module 105 includes a traffic monitor 207. This monitor can sniff packets on the network 204, receive data from packet sniffers throughout the network, or use other techniques to identify payloads moving on the network including the source and destination addresses. The AR device module 205 also includes a digitizer 208 to digitize this information for use by the display generator 209.

As described above, the display generator 209 may utilize a default or a selected display model 211 to render visual elements on the transparent display of the viewer 203 that visualizes for the administrator 202 the network activity occurring in real time on the network 204. This activity may be between IoT 206 or other network devices. This activity may take different forms such as payloads moving in a VPN or moving regularly with VPN encryption. For example, the model may specify a particular color or shape for elements representing different types of payloads. The model may include specific icons or a style of icons for different types of network activity.

The AR device module 205 may also include a user interface 210. This user interface 210 may include elements of the device 201, such as a keyboard, mouse and display screen. Additionally or alternatively, the user interface 210 may include any of the components and techniques described above for accepting user input in an AR environment including voice commands, gestures, etc.

In operation, use of the tool provided by the AR device module 205 may begin with the user operating the interface 210 of the tool to initiate a session. The administrator 202 may first determine 250 a specific device or devices on the network for which activity is to be visualized and a display model to be used for the visualization. For example, the user opts into a corresponding module on the local device of interest such as one or more of the IoT devices, networking devices (Modem/router) and server side or non-local components. The relevant traffic data from the selected devices is collected and provided to the module 205 from which the AR environment is generated. The administrator 202 may select a display model for the AR session. The administrator 202 may physically configure, map and decide a display manner of the module 205, e.g., the physical location of adjacent IoT devices; the speed, color, and displayed metadata of payloads in the AR space; and the length of time of message or payload persistence in the AR space.

If not already operating, the administrator then connects or activates the AR environment including the viewer 203. For example, the user connects an AR device to the module and begins actively interacting as normal on their device.

The AR device module 205 will then capture 252 information about data traffic, specifically the inbound/outbound traffic for the selected device or devices of the network 204. For example, outbound and inbound traffic are identified and the source and destination IP addresses are captured. For the traffic, it is determined if the traffic is local or non-local. In some examples, data is collected on the trend of non-local data hopping back to another device (client to server to other IoT client). It is also determined whether the traffic is encrypted via a VPN or protected in some other way. The context and metadata of the payload are also captured. Payload metadata may be initially defined or learned via a Convolutional Neural Network (CNN) module. Metadata may include action (POST request) or context (Open Garage Door).

For inbound traffic, the module may determine which local device receives the payload and capture the source IP address and IP family. The module 205 can also generate a representative payload to understand the type of data sent. As inbound payloads arrive, metadata and other source information may also be captured.

All of this data may be organized in a tabular format when received by the AR module 205. The digitizer 208 is then used to convert or digitize 253 the traffic data for visualization. Specifically, the digitizer 208, also referred to as an case of view module, can display the family of the items, the metadata, source information, included/encrypted payloads. The digitizer 208 applies a slowdown to the items so the administrator is able to digest the information.

The display generator 209 then generates 254 the display elements based on the selected display model and displays the display elements in the viewer 203. The location and orientation of the viewer 203 are detected so that the display elements are displayed in proper relation to the real-world components being seen by the administrator 202 through the viewer 203. The administrator 202 will then be able to understand the network activity more quickly and accurately. As a result, the administrator 202 can more readily identify inefficiencies or problems in the network and take remedial action to adjust the network activity or repair or update network components as needed.

FIG. 3B is a diagram of another example of the tool described herein and its operation. FIG. 3B illustrates the same components and their operation as described above in FIG. 3A. In FIG. 3B, however, additional functionality is utilized. Specifically, after generation of the visualization for the user, the user interface 210 allows the user to interact 255 with the displayed model in the AR space using, for example, any of the AR user interface techniques described above. This allows the user to change the operation of the network 204, such as pausing a payload transmission. In other examples, the user may optionally interact with the visualization elements, such as payload/data representations, to drill down/expand the visualization.

When each user action is completed 256, the instructions given by the user are implemented in the operation of the network 204. The visualization of the network's activity is then updated accordingly. For example, the resulting network activity is again detected, including capturing 252 the context and identifying inbound/outbound traffic, digitizing 253 the traffic for visualization, generating 254 the model with display elements for the display in the viewer 203. This can continue as long as the user interacts 256 with the AR space and until the user concludes the session.

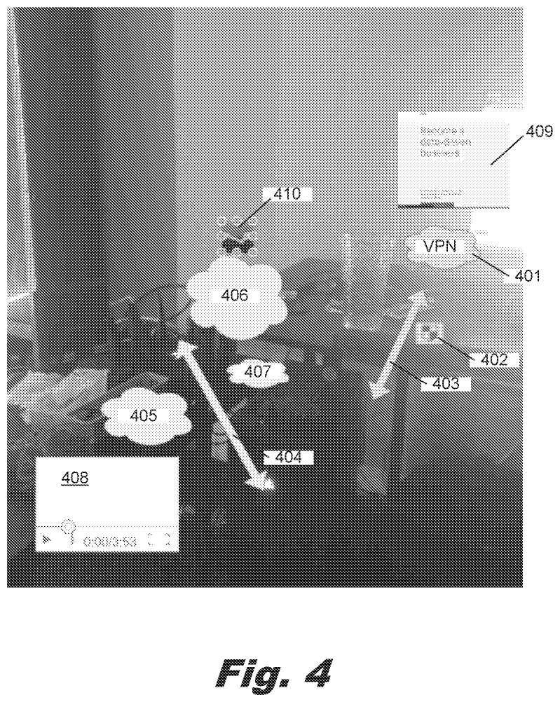

FIG. 4 is an example of an augmented reality scene that might be viewed using the tool described herein. In this example, the network is implementing VPN split tunneling, as described above. Specifically, some of the traffic is moving out of the local network via a VPN 401. The arrow 403 indicates the traffic flowing from a local traffic endpoint to the VPN. A shield icon 402 may be displayed indicating that this traffic is protected by encryption via the VPN. This data being transmitted via the VPN may be, for example, an important document or other content. Accordingly, an icon 409 may be displayed representing or identifying the content that is being transmitted via the VPN.

The other arrow 404 indicates other external traffic via the network gateway that is not moving in the VPN. The two arrows may be of different colors or otherwise visually distinguished to demonstrated use of the split tunneling. In the illustrated example, this other traffic that is associated with arrow 404 includes three data streams or payloads 405, 406 and 407. In the visualization, each of these payloads may be represented by a cloud, as shown in FIG. 4. The size of the cloud corresponds to the relative size of the data stream.

The largest cloud and largest data stream 406 may be from a digital distribution platform for video games or other content. This cloud may be accompanied by a displayed icon 410 that represents the content being downloaded from the digital distribution platform. The next largest cloud 405 may represent a stream from a video service, such as YouTube®. In this case, the visualization may include a representation 408 of a video frame or video player to indicate that that the stream 405 is for video content. The smallest cloud 407 may represent background services, for example, utilized by an operating system or environment, such as Microsoft®.

Thus, using the tool described herein, the user can, at a glance, see what major sources of traffic are ongoing, what data is sent where, and what data is protected, e.g., via VPN. The module will capture the user's IoT network contexts and networking behavior on each connected device, understand source and destination IP addresses and display the payloads physically in the AR Space. As will be appreciated, there are a great many different variations and features that can be implemented in the visualization tool described herein. Some examples will now be described.

As noted above, the user interface of the AR device may be used to control network operation after the operation has been visualized. Also, the visualization in the AR environment may be controlled by AR input. For example, payloads may be organized, modified, or displayed in a manner that may allow the user to modify the speed of the visualization or condense multi-hop exchanges. The user interface also provides for the user to adjust the size of elements in the AR visualization.

While FIG. 4 primarily illustrates traffic leaving/entering the local network, traffic among components within the local network can be represented in similar fashion. Local and non-local traffic may be represented with visual differences, such as differently colored, shaped or structured arrows to readily distinguish internal and external traffic. In addition to current traffic, pre and post received traffic/payloads may also be captured and displayed visually according to the principles described herein for the user. Similarly, the size or weight of the arrows in the visualization may be indicative of the amount of data traversing the indicated tunnel. Similarly, in another example, a heartbeat signal may be displayed, for example, along with the VPN transmission, where the heartbeat signal is displayed as a skinny line, while the larger page transmission/reception from a source over the VPN is displayed as the thick line 403, shown in FIG. 4.

Some VPN providers use abbreviations or logos as branding. Consequently, in an example, a smartphone that is connected to the network and using a VPN could be associated with a line to the VPN in the AR visualization. A logo or abbreviation of the VPN provider could also be displayed floating above the phone to advise the user of what VPN the phone, or other networked device, is using.

As described, the AR modules allows the user to map out device location so as to “draw” the data routes successfully in the AR environment. For example, the user can walk around a house with the AR viewer mapping the devices, so the payloads can travel realistically through the house.

The described tool also provides for identification of slowing bandwidth issues or payloads at timeboxed risk of failure. If there are issues with the flow of data through a pipe, or a possible slow-down from normal processing speed beyond normal processing cycles, the tool can alert the user with a visual triggering notification within the AR overlay interface. This notification will allow the user to investigate within real time rather than discover the issue at a later point when the payload was not completed or not successful altogether. In sum, the described tool provides a system and method where an augmented reality based device will transform the source, destination, magnitude, and payload metadata into a visually understandable manner for network communications.

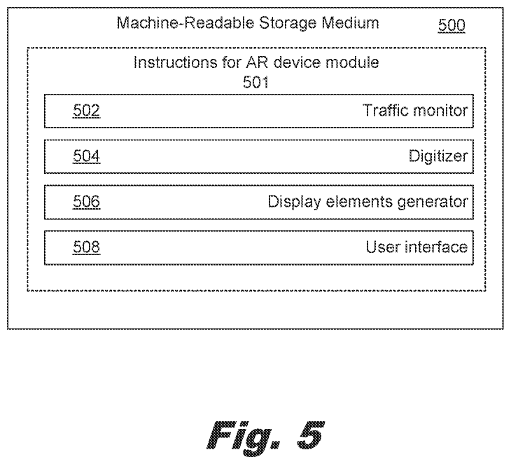

FIG. 5 is a diagram of a machine-readable storage medium for implementing an example of the tool described herein. As shown in FIG. 5, the instructions 501 for the AR device module, as described herein, are stored on a machine-readable storage medium 500. These instructions include instructions for implementing the elements described above, namely, instructions 502 for a traffic monitor, instructions 504 for a digitizer, instructions 506 for a generator to generate the display elements representing the network activity in an AR environment, and instructions 508 for a user interface that allows the user to control the module and AR environment as described herein.

In conclusion, aspects of the system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. In one example, the computer usable program code may be embodied within a computer readable storage medium; the computer readable storage medium being part of the computer program product. In one example, the computer readable storage medium is a non-transitory computer readable medium.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A tool for administering a computer network comprising:
an augmented reality (AR) device comprising a computing device and a viewer through which an administrator views a physical space comprising a part of the computer network; and
an AR device module structured to identify data traffic on the computer network and display visual elements in an AR environment of the viewer that indicate network activity on the computer network to the administrator, wherein the visual elements are displayed on one or more network components comprising the computer network and which are involved in the network activity, and wherein the visual elements indicate a payload of the data traffic.

2. The tool of claim 1, wherein the augmented reality device module is structured to:
capture Internet of Things (IoT) contexts and network behavior for each IoT device connected to the network and source and destination addresses of payloads in the computer network; and
display visual elements in the viewer that represent the payloads in the AR environment.

3. The tool of claim 1, further comprising a user interface of the AR device through which the administrator inputs commands via voice or gesture to alter the data traffic on the computer network, the AR device executing the commands to alter the data traffic on the computer network.

4. The tool of claim 1, wherein the AR device module is structured to distinguish between protected and unprotected data traffic, wherein a visual element representing protected data traffic is visually distinguished from a corresponding visual element representing unprotected data traffic.

5. The tool of claim 4, wherein the protected data traffic is transmitted via a Virtual Private Network (VPN).

6. The tool of claim 1, wherein the AR device module comprises:
a traffic monitor; and
a display generator to generate the visual elements in a spatial relationship with components of the computer network seen through the viewer.

7. The tool of claim 1, further comprising a database of display models selectable by the administrator for defining the visual elements.

8. A computer-implemented method for administering a computer network comprising;
capturing Internet of Things (IoT) contexts and networking behavior for a number of networked devices;
identifying source and destination addresses of payloads in the network;
arranging information comprising the IoT contexts, networking behavior and source and destination addresses for display in an augmented reality (AR) space; and
visualizing network activity in the AR space with visual elements representing the network activity displayed in a spatial arrangement corresponding to real-world components of the network viewed in the AR space, wherein the visual elements are displayed on one or more network components comprising the computer network and which are involved in the network activity, and wherein the visual elements indicate a payload of the data traffic.

9. The method of claim 8, further comprising:
with a user interface, accepting user input to control the network activity; and
implementing the user input to alter the network activity.

10. The method of claim 9, wherein the user input comprises instructions to pause or disallow a payload transmission in the computer network.

11. The method of claim 8, further comprising distinguishing between protected and unprotected data traffic in the network, wherein a visual element in the AR space representing protected data traffic is visually distinguished from a corresponding visual element representing unprotected data traffic.

12. The method of claim 11, wherein the protected data traffic is transmitted via a Virtual Private Network (VPN).

13. The method of claim 8, wherein the visual elements are generated base on a display model from a database of selectable display models.

14. The method of claim 8, wherein the visual elements comprise arrows illustrating movement of payloads in the network.

15. The method of claim 8, wherein the visual elements comprise a number of icons that represent content of a corresponding payload moving in the network.

16. A computer program product comprising a non-transitory, machine-readable medium that stores instructions, the instructions comprising:
instructions for a traffic monitor to monitor traffic on a computer network;
instructions for a digitizer to convert information on network activity obtained by the traffic monitor for display in an augmented (AR) reality environment; and
instructions for a display elements generator to generate visual elements in the AR environment that correspond to different aspects of the network activity occurring in the computer network, wherein the visual elements are displayed on one or more network components comprising the computer network and which are involved in the network activity, and wherein the visual elements represent differently local traffic and non-local traffic, and wherein the visual elements indicate a payload of the data traffic.

17. The product of claim 16, further comprising instructions for a user interface with which a network administrator inputs commands for controlling the network activity.

18. The product of claim 17, wherein the commands comprise pausing or disallowing a payload transmission in the computer network.

19. The product of claim 16, wherein the instructions for the traffic monitor comprise instructions for:
capturing Internet of Things (IoT) contexts and networking behavior for a number of networked devices; and
identifying source and destination addresses of payloads in the network.

20. The product of claim 16, wherein the instructions for the display elements generator comprise instructions for generating, among the visual elements, a number of icons that represent content of a corresponding payload moving in the network.
